(19) United States
(12) Patent Application Publication
(10) Pub. No.: US 2024/0271654 A1
(43) Pub. Date: Aug. 15, 2024

(54) FLOW DRILL SCREW AND TIP CONFIGURATION

(71) Applicants: Ford Global Technologies, LLC, Dearborn, MI (US); Semblex Corporation, Elmhurst, IL (US)

(72) Inventors: Amanda Kay Freis, Ann Arbor, MI (US); Garret Sankey Huff, Ann Arbor, MI (US); Brandt J. Ruszkiewicz, Cumming, GA (US); Stephen J. Crockett, Bartlett, IL (US)

(73) Assignees: Ford Global Technologies, LLC, Dearborn, MI (US); Semblex Corporation, Elmhurst, IL (US)

(21) Appl. No.: 18/587,216

(22) Filed: Feb. 26, 2024

Related U.S. Application Data
(63) Continuation-in-part of application No. 18/168,280, filed on Feb. 13, 2023.

(51) Int. Cl. F16B 25/00; F16B 5/02; F16B 25/10

(52) U.S. Cl. CPC F16B 25/0084; F16B 5/02; F16B 25/0021; F16B 25/0068; F16B 25/106

(57) ABSTRACT

A screw includes a head portion, an externally threaded shank extending from the head portion, the externally threaded shank having an external surface, and a flow-hole-forming tip disposed at a distal end portion of the externally threaded shank. The flow-hole-forming tip includes a convex radiused lower zone having an external surface, a concave radiused middle zone having an external surface tangent to the external surface of the convex radiused lower zone, and a radiused distal end zone having an external surface tangent to the external surface of the concave radiused middle zone.

### CROSS-REFERENCE TO RELATED APPLICATION

This application is a continuation-in-part of and claims the benefit of U.S. application Ser. No. 18/168,280, filed Feb. 13, 2023, and titled “FLOW DRILL SCREW AND TIP CONFIGURATION,” the contents of which are incorporated herein by reference in their entirety.

### FIELD

The present disclosure relates generally to fasteners and more particularly to flow drill screw (FDS) type fasteners, which are often used in joining adjacent workpieces with one-sided access.

### BACKGROUND

The statements in this section merely provide background information related to the present disclosure and may not constitute prior art.

A variety of structures being joined often require one-sided joining techniques in order to create efficient assemblies. One such technique for one-sided joining is flow-drill screwing, in which a threaded fastener (or FDS) is installed into a joint and a “nut” or “bushing” is created within one of the workpieces of the joint in situ during the installation process.

In automotive structures, castings are increasingly being introduced into body structures to reduce part count and decrease assembly time. However, when FDS fasteners are used with these castings, the quality of the bushing can be more inconsistent than with traditional body structure materials fabricated by different processes (e.g., sheet metal and extrusions). A lower quality bushing will reduce thread engagement and can result in an improper installation, which can lead to reduced joint strength and corrosion concerns.

These issues related to the use of FDS type fasteners with structural castings, among other issues related to FDS installations and assemblies, are addressed by the present disclosure.

### SUMMARY

This section provides a general summary of the disclosure and is not a comprehensive disclosure of its full scope or all of its features.

In one form of the present disclosure, a screw is provided that includes: a head portion; an externally threaded shank extending from the head portion, the externally threaded shank having an external surface; and a flow-hole-forming tip disposed at a distal end portion of the externally threaded shank, wherein the flow-hole-forming tip includes: a convex radiused lower zone having an external surface; a concave radiused middle zone having an external surface tangent to the external surface of the convex radiused lower zone; and a radiused distal end zone having an external surface tangent to the external surface of the concave radiused middle zone.

In variations of this screw, which may be implemented individually or in any combination: the convex radiused lower zone has an external surface tangent to the external surface of the externally threaded shank; further includes a conical zone extending between the convex radiused lower zone and the external surface of the externally threaded shank, wherein the conical zone defines an external surface that is tangent to the external surface of the externally threaded shank and an external surface of the convex radiused lower zone; further includes a cylindrical zone disposed between the externally threaded shank and the flow-hole-forming tip; a distance from an end of the radiused distal end zone to a start of the externally threaded shank is less than about 15 mm; the flow-hole-forming tip does not include a cutting edge; the concave radiused middle zone has a radius between about 1.5 mm and about 3.5 mm; a width of the flow-hole-forming tip is between about 0.2 to about 0.8 times a length of the flow-hole-forming tip; a radius of the convex radiused lower zone is at least 2 times greater than a radius of the radiused distal end zone; the radiused distal end zone defines a surface roughness (Ra) greater than a surface roughness of the convex radiused lower zone; the externally threaded shank includes multi-helix threads; and further includes a coating disposed over at least a portion of the screw.

In another form of the present disclosure, a structural assembly is provided that includes: a plurality of workpieces; and a screw disposed between the plurality of workpieces, the screw including: a head portion; an externally threaded shank extending from the head portion, the externally threaded shank having an external surface; and a flow-hole-forming tip disposed at a distal end portion of the externally threaded shank, wherein the flow-hole-forming tip includes: a convex radiused lower zone having an external surface; a concave radiused middle zone having an external surface tangent to the external surface of the convex radiused lower zone; and a radiused distal end zone having an external surface tangent to the external surface of the concave radiused middle zone.

In variations of this structural assembly, which may be implemented individually or in any combination: at least one of the workpieces includes a casting; the casting is one of an aluminum material or a magnesium material; the casting is an Al—Si grade aluminum material; at least one of the workpieces includes an aluminum sheet; at least one of the workpieces includes an aluminum extrusion; and further includes a coating disposed over at least a portion of the screw.

In another form of the present disclosure, a structural assembly is provided that includes: a plurality of workpieces, wherein each of the plurality of workpieces includes a casting; and a screw disposed between the plurality of workpieces, the screw including: a head portion; an externally threaded shank extending from the head portion, the externally threaded shank having an external surface; and a flow-hole-forming tip disposed at a distal end portion of the externally threaded shank, wherein the flow-hole-forming tip includes: a convex radiused lower zone having an external surface; a concave radiused middle zone having an external surface tangent to the external surface of the convex radiused lower zone; and a radiused distal end zone having an external surface tangent to the external surface of the concave radiused middle zone, and wherein the flow-hole-forming tip does not include a cutting edge.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a bottom perspective view of a screw having a flow-hole-forming tip constructed according to the teachings of the present disclosure;

FIG. 2 is a side view of the screw of FIG. 1;

FIG. 3A is an enlarged detail view, taken from detail 3-3 of FIG. 2, of a first variation of the flow-hole-forming tip of FIG. 1;

FIG. 3B is an enlarged detail view of a second variation of the flow-hole-forming tip according to the teachings of the present disclosure;

FIG. 3C is an enlarged detail view of a third variation of the flow-hole-forming tip according to the teachings of the present disclosure;

FIG. 3D is an enlarged detail view of a fourth variation of the flow-hole-forming tip according to the teachings of the present disclosure; and

FIG. 4 is a side cross-sectional view of the screw of FIG. 1 installed into workpieces of a structural assembly according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

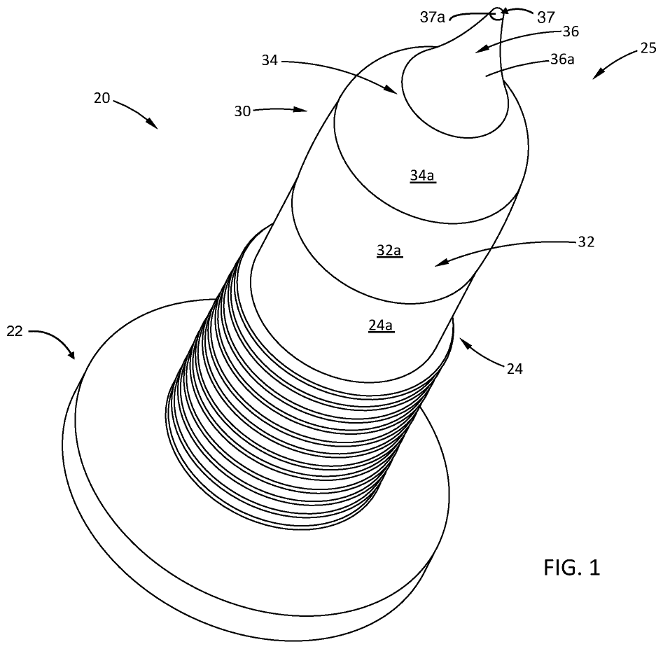

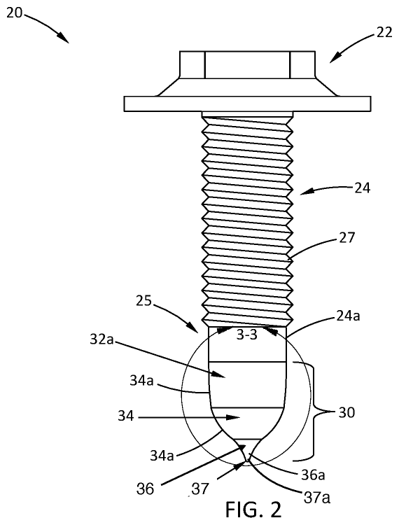

Referring to FIGS. 1 and 2, a screw according to the teachings of the present disclosure is illustrated and generally indicated by reference numeral 20. The screw 20 generally includes a head portion 22, an externally threaded shank 24 extending from the head portion 22, and a flow-hole-forming tip 30 disposed at a distal end portion 25 of the externally threaded shank 24. The externally threaded shank 24 also includes an external surface 24a. The screw 20 is an FDS type fastener and is used for flow drill screwing, the installation of which is set forth in greater detail below. It should be understood that the specific hex design of the head portion 22 illustrated is merely exemplary, and thus other head designs such as slotted or a Torx® style head portion, among other head features (e.g., washers, coatings, knurls), may be employed while remaining within the scope of the present disclosure. Further, the externally threaded shank 24 includes at least one threadform 27 that extends helically about the rotational axis of the screw 20 as shown. The threadform 27 may extend along a portion or the entire length of the externally threaded shank 24 and thus the illustrated threadform 27 should not be construed as limiting the scope of the present disclosure. In the example provided, a single threadform 27 is used (i.e., a single-helix). Additionally, different types and sizes of threadforms 27 may be employed, such as by way of example, multi-helix threads, while remaining within the scope of the present disclosure.

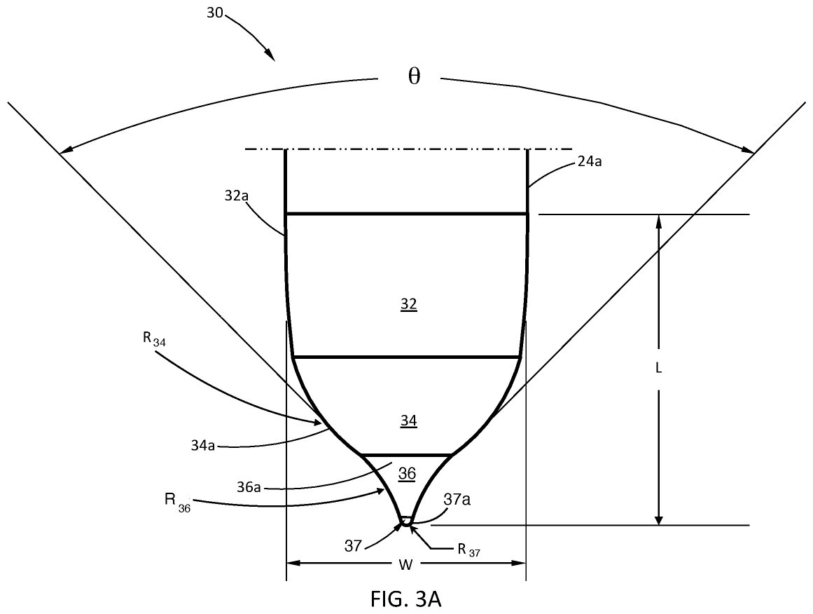

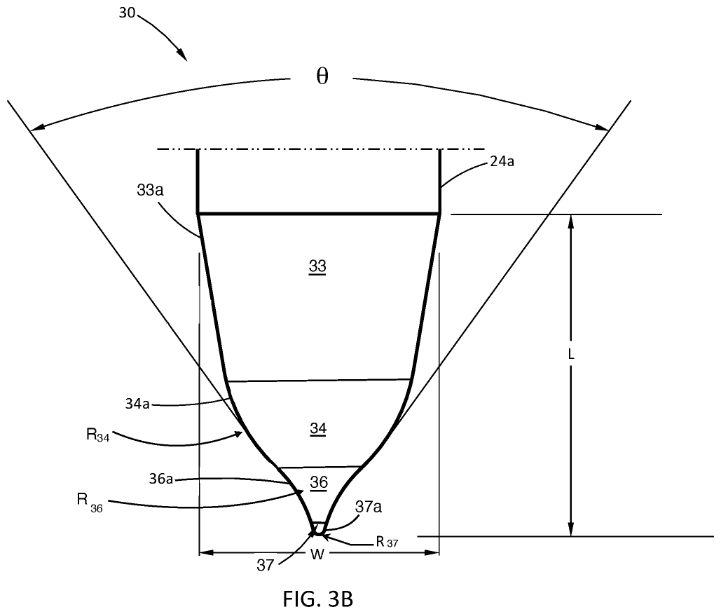

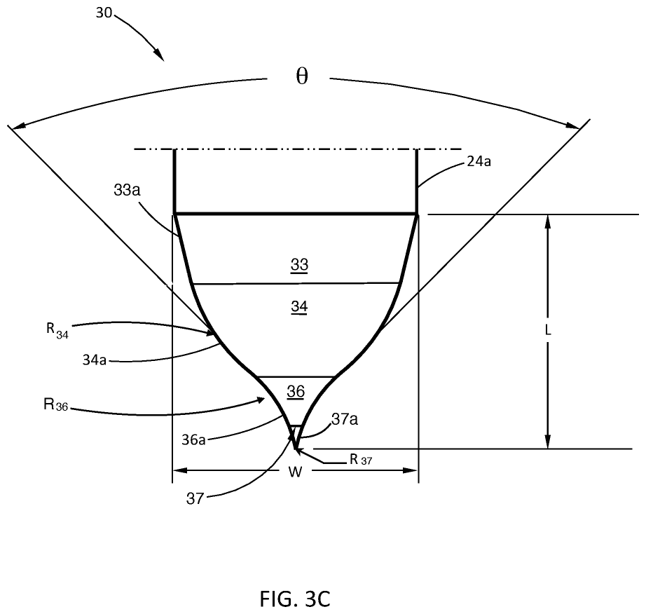

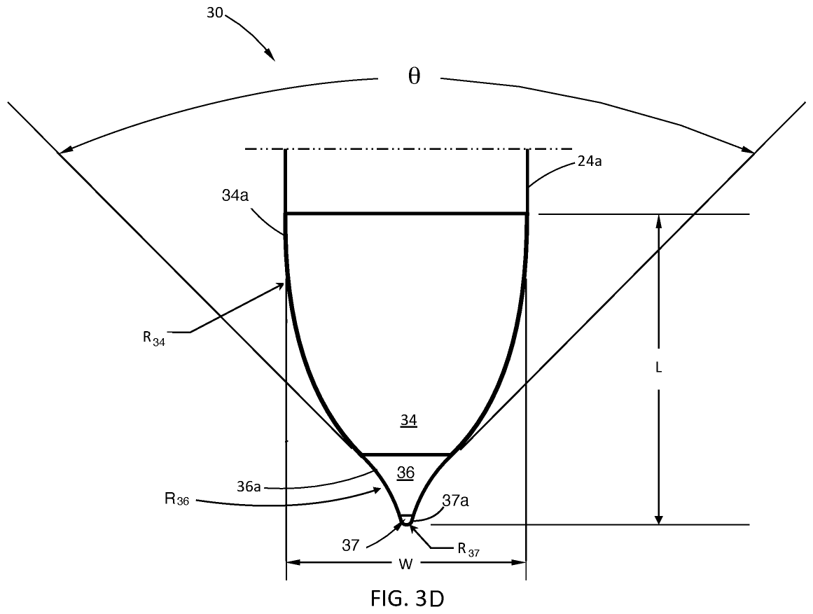

Now referring to FIGS. 3A-3D, variations of a flow-hole-forming tip 30 are illustrated and described in greater detail. The flow-hole-forming tip 30 comprises three (3) zones: 1) a convex radiused lower zone 34, which includes an exterior surface 34a; 2) a concave radiused middle zone 36, which includes an exterior surface 36a and 3) a radiused distal end zone 37, which includes an exterior surface 37a. In one form, the exterior surface 36a of the concave radiused middle zone 36 is tangent to the exterior surface 34a of the convex radiused lower zone 34, and the exterior surface 37a of the radiused distal end zone 37 is tangent to the exterior surface 36a of the concave radiused middle zone 36. It should be understood, however, that other types of transitions between the different zones (in each of the variations illustrated and described below) other than tangent are contemplated by the teachings herein. In one form, the concave radiused middle zone 36 has a radius R₃₆ between about 1.5 mm and about 3.5 mm.

Referring to FIG. 3A, a first version of the flow-hole-forming tip 30 may also include a cylindrical zone 32, which includes an exterior surface 32a. In this form, the exterior surface 32a of the cylindrical zone 32 is tangent to the exterior surface 24a of the externally threaded shank 24, and the exterior surface 34a of the convex radiused lower zone 34 is tangent to the external surface 32a of the cylindrical zone 32. In one exemplary form, the radius R₃₄ of the convex radiused lower zone 34 is approximately 3 mm and the radius R₃₆ of the concave radiused middle zone 36 is approximately 2.5 mm.

Referring to FIG. 3B and 3C, a second and a third version, respectively, of the flow-hole-forming tip 30 includes a conical zone 33, which includes an exterior surface 33a. In this form, the exterior surface 33a of the conical zone 33 is tangent to the exterior surface 24a of the externally threaded shank 24, and the exterior surface 34a of the convex radiused lower zone 34 is tangent to the external surface 33a of the conical zone 33. As shown, the conical zone 33 of FIG. 3C may be shorter than the conical zone 33 of FIG. 3B. Additionally, the conical zone 33 of FIG. 3B may be longer than the cylindrical zone 32 of FIG. 3A.

In one form, the radius R₃₆ of the concave radiused middle zone 36 of FIG. 3C is larger than the radius R₃₆ of the concave radiused middle zone 36 of FIG. 3A and 3B. In one form, the radius R₃₆ of the concave radiused middle zone 36 of FIG. 3C is about 2 mm and the radius R₃₆ of the concave radiused middle zone 36 of FIG. 3B is about 2.5 mm. Additionally, the radius R₃₄ of the convex radiused lower zone 34 of FIG. 3C is about 2.7 mm and the radius R ₃₄ of the convex radiused lower zone 34 of FIG. 3B is about 2.9 mm.

Referring to FIG. 3D, a fourth version of the flow-hole-forming tip 30 does not include a conical zone. Rather, the exterior surface 34a of the convex radiused lower zone 34 is transitions directly to the exterior surface 24a of the externally threaded shank 24. In one form, this transition may be tangent as shown. In one form, the radius R₃₆ of the concave radiused middle zone 36 may be the same as that of 3A, 3B, or 3C. In another form the concave radiused middle zone 36 is about 2.5 mm and the convex radiused lower zone is about 6.8 mm.

Now referring to each of FIGS. 3A-3D, the exterior surface 24a of the externally threaded shank 24 is a portion that lacks the threadform 27 (FIG. 2) and is axially disposed between the threadform 27 and the convex radiused lower zone 34. In one variation, the exterior surface 24a of the externally threaded shank 24 is axially disposed between the threadform 27 and the cylindrical zone 32. In another variation, the exterior surface 24a of the externally threaded shank 24 is axially disposed between the threadform 27 and the conical zone 33. In one form, the exterior surface 24a is parallel to the rotational axis of the screw 20. In another form, the exterior surface 24a may be tapered such that it narrows as it approaches the cylindrical zone 32, conical zone 33, or the convex radiused lower zone 34. The diameter of the exterior surface 24a may be less than or equal to the minimum diameter of the threadform 27.

In general, the flow-hole-forming tip 30 is specifically designed to penetrate castings, and more specifically castings formed from materials that are relatively brittle, such as aluminum (e.g., 7xxx series) or magnesium. It should be understood, however, that the innovative flow-hole-forming tip 30 can be used with other materials, and also with structures/workpieces that are formed with other manufacturing methods besides castings, such as by way of example, additive manufacturing, while remaining within the scope of the present disclosure.

As shown, the convex radiused lower zone 34 defines a vertex angle θ as shown, which in one form is greater than or equal to 90 degrees. Accordingly, with such a large angle, the flow-hole-forming tip 30 is more blunt than conventional flow-hole-forming tips. In one form the vertex angle is greater than 100 degrees, such as about 108 degrees, as shown in FIG. 3A, or about 104 degrees, as shown in FIG. 3C. In another form the vertex angle is less than 100 degrees such as about 92 degrees, as shown in FIG. 3B, or 98 degrees, as shown in FIG. 3D.

In another form, a width W of the flow-hole-forming tip 30 is greater than a length L of the flow-hole-forming tip 30, which also provides for a more blunt flow-hole-forming tip 30. In one variation, the width W of the flow-hole-forming tip 30 is about 0.2 to about 1.1 times the length L of the flow-hole-forming tip 30. (i.e., 0.2<=W/L<=1.1). The length L is the distance from an end of the radiused distal end zone 37 to a start of the externally threaded shank 24. In one form, the length L is less than about 15 mm. In one variation the width-to-length (W/L) ratio is about 0.78 as shown in FIG. 3A. In another variation the width-to-length ratio is about 0.75 as shown in FIGS. 3B and 3D. In yet another variation the width-to-length ratio is about 1.04 as shown in FIG. 3C.

In one form, the radiused distal end zone 37 defines a surface roughness (Ra) greater than a surface roughness of the convex radiused lower zone 34. This surface roughness provides micro features that can more easily penetrate workpieces (described in greater detail below) without the use of a defined cutting edge or a pinched tip as is known in the art. The surface roughness is generally between about 1 μm Ra and about 10 μm Ra. In one form, the Ra is about 5 μm Ra. Accordingly, the flow-hole-forming tip 30 according to the teachings herein does not include such a cutting edge as is used with prior art FDS type fasteners. Thus, the flow-hole-forming tip 30 generally defines a circular cross-section, taken perpendicular to the rotational axis, along its length L as shown.

The concave radiused middle zone 36 transitions into a narrow radiused distal end zone 37. In one variation, a radius R₃₄ of the convex radiused lower zone 34 is at least 2 times greater than a radius R₃₇ of the radiused distal end zone 37. In another form, the radius R₃₇ of the radiused distal end zone 37 is less than 0.5 mm. In one variation, the radius R₃₇ of the radiused distal end zone 37 is about 0.2 mm, as shown in FIG. 3A. In another variation, the radius R₃₇ of the radiused distal end zone 37 is about 0.1 mm, as shown in FIGS. 3B and 3D. In yet another variation, the radius R₃₇ of the radiused distal end zone 37 is about 0.05 mm, as shown in FIG. 3C. The reduction of the width W of the flow-hole-forming tip 30 to the radius R₃₇ of the radiused distal end zone 37 aids in locating the screw 20 to the intended location in a workpiece. These features of the flow-hole-forming tip 30, namely, the vertex angle θ, the surface roughness, the W/L ratio, and the radius values/ratios may be used individually or in any combination according to the teachings herein to achieve a more blunt flow-hole-forming tip 30 that is more able to penetrate castings while creating a robust, higher quality joint.

In another form, the flow-hole-forming tip 30 comprises a friction coating applied to at least a portion thereof, such as by way of example, the radiused distal end zone 37. The friction coating may be applied to a portion of or over the entirety of one or more of the radiused distal end zone 37, the concave radiused middle zone 36, and/or the convex radiused lower zone 34. In other forms, the friction may also be applied to a portion of or over the entirety of the conical zone 33 or the cylindrical zone 32. Exemplary friction coatings include, but are not limited to, electroless nickel dispersion or ceramic coatings, among others.

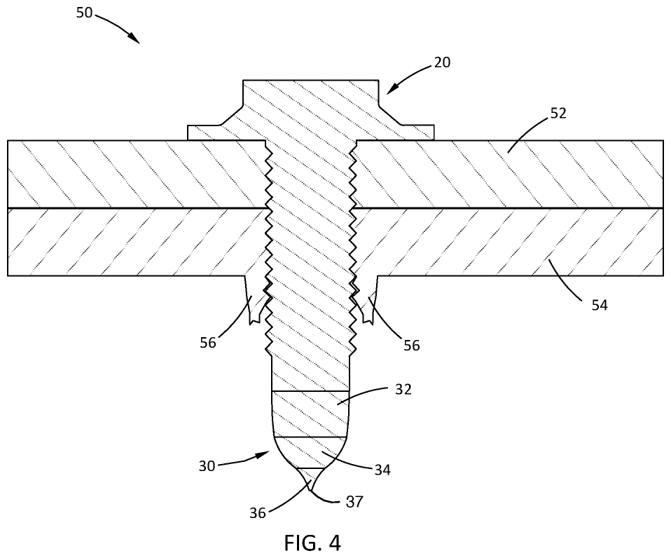

Referring now to FIG. 4, a structural assembly having the innovative screw 20 as set forth herein is illustrated and generally indicated by reference numeral 50. The structural assembly 50 includes a plurality of workpieces 52, 54, which are joined together by the screw 20. It should be understood that any number of workpieces (e.g., three or more) can be employed while remaining within the scope of the present disclosure. In one form, at least one of the workpieces 52, 54 is a casting, and more specifically the casting is an aluminum material or a magnesium material. In one form, the aluminum material is a 7xxx series aluminum. In one form, the casting is an Al—Si grade aluminum material. In another form, at least one of the workpieces 52, 54, is an aluminum sheet. In yet another form, at least one of the workpieces 52, 54, is an aluminum extrusion.

The screw 20 can include any of the variations described above, and includes the flow-hole-forming tip 30 having at least the three (3) zones, namely, the convex radiused lower zone 34, the concave radiused middle zone 36, and the radiused distal end zone 37. After the screw 20 is installed, a bushing 56 is formed in the lower workpiece 54 as shown. The bushing 56 is formed as the lower workpiece 54 is pierced and plastically deformed by the screw 20, and more specifically by the flow-hole-forming tip 30. Overall, the bushing 56 is of a higher quality with the use of the flow-hole-forming tip 30 according to the teachings herein, and especially when one or more of the workpieces 52, 54 are castings. It should be understood, however, that the teachings of the present disclosure are not limited to castings, and thus the screw 20 with the innovative flow-hole-forming tip 30 can be employed with a variety of parts/workpieces formed from other manufacturing methods, such as by way of example, additive manufacturing, machining, extruding, and stamping, among others.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A screw comprising:
a head portion;
an externally threaded shank extending from the head portion, the externally threaded shank having an external surface; and
a flow-hole-forming tip disposed at a distal end portion of the externally threaded shank,
wherein the flow-hole-forming tip comprises:
a convex radiused lower zone having an external surface;
a concave radiused middle zone having an external surface tangent to the external surface of the convex radiused lower zone; and
a radiused distal end zone having an external surface tangent to the external surface of the concave radiused middle zone.

2. The screw according to claim 1, wherein the convex radiused lower zone has an external surface tangent to the external surface of the externally threaded shank.

3. The screw according to claim 1, further comprising a conical zone extending between the convex radiused lower zone and the external surface of the externally threaded shank, wherein the conical zone defines an external surface that is tangent to the external surface of the externally threaded shank and an external surface of the convex radiused lower zone.

4. The screw according to claim 1, further comprising a cylindrical zone disposed between the externally threaded shank and the flow-hole-forming tip.

5. The screw according to claim 1, wherein a distance from an end of the radiused distal end zone to a start of the externally threaded shank is less than about 15 mm.

6. The screw according to claim 1, wherein the flow-hole-forming tip does not include a cutting edge.

7. The screw according to claim 1, wherein the concave radiused middle zone has a radius between about 1.5 mm and about 3.5 mm.

8. The screw according to claim 1, wherein a width of the flow-hole-forming tip is between about 0.2 to about 0.8 times a length of the flow-hole-forming tip.

9. The screw according to claim 1, wherein a radius of the convex radiused lower zone is at least 2 times greater than a radius of the radiused distal end zone.

10. The screw according to claim 1, wherein the radiused distal end zone defines a surface roughness (Ra) greater than a surface roughness of the convex radiused lower zone.

11. The screw according to claim 1, wherein the externally threaded shank comprises multi-helix threads.

12. The screw according to claim 1, further comprising a coating disposed over at least a portion of the screw.

13. A structural assembly comprising:
a plurality of workpieces; and
a screw disposed between the plurality of workpieces, the screw comprising:
a head portion;
an externally threaded shank extending from the head portion, the externally threaded shank having an external surface; and
a flow-hole-forming tip disposed at a distal end portion of the externally threaded shank,
wherein the flow-hole-forming tip comprises:
a convex radiused lower zone having an external surface;
a concave radiused middle zone having an external surface tangent to the external surface of the convex radiused lower zone; and
a radiused distal end zone having an external surface tangent to the external surface of the concave radiused middle zone.

14. The structural assembly according to claim 13, wherein at least one of the workpieces comprises a casting.

15. The structural assembly according to claim 14, wherein the casting is one of an aluminum material or a magnesium material.

16. The structural assembly according to claim 14, wherein the casting is an Al—Si grade aluminum material.

17. The structural assembly according to claim 13, wherein at least one of the workpieces comprises an aluminum sheet.

18. The structural assembly according to claim 13, wherein at least one of the workpieces comprises an aluminum extrusion.

19. The structural assembly according to claim 13, further comprising a coating disposed over at least a portion of the screw.

20. A structural assembly comprising:
a plurality of workpieces, wherein each of the plurality of workpieces comprises a casting; and
a screw disposed between the plurality of workpieces, the screw comprising:
a head portion;
an externally threaded shank extending from the head portion, the externally threaded shank having an external surface; and
a flow-hole-forming tip disposed at a distal end portion of the externally threaded shank,
wherein the flow-hole-forming tip comprises:
a convex radiused lower zone having an external surface;
a concave radiused middle zone having an external surface tangent to the external surface of the convex radiused lower zone; and
a radiused distal end zone having an external surface tangent to the external surface of the concave radiused middle zone, and
wherein the flow-hole-forming tip does not include a cutting edge.
